(19) United States
(12) Patent Application Publication
(10) Pub. No.: US 2025/0332948 A1
(43) Pub. Date: Oct. 30, 2025

(54) CONTROL SYSTEM FOR ELECTRIC VEHICLE

(71) Applicant: ISUZU MOTORS LIMITED, Yokohama-shi (JP)

(72) Inventor: Yuki TEMMA, Fujisawa-shi (JP)

(21) Appl. No.: 19/057,129

(22) Filed: Feb. 19, 2025

(30) Foreign Application Priority Data
Apr. 30, 2024 (JP) 2024-073940

(51) Int. Cl. B60L 53/80; B60L 58/10

(52) U.S. Cl. CPC B60L 53/80; B60L 58/10

(57) ABSTRACT

Control system Cu for electric vehicle C according to the present disclosure includes: vehicle ECU 202; ignition power source E1 that starts power supply to vehicle ECU 202 in response to a vehicle activation operation by a user; battery replacement switch 101 that receives a replacement command operation for battery 11 from the user; and first relay 203 that is disposed in electric circuit L1 connecting between ignition power source E1 and vehicle ECU 202, so as to be in conjunction with an on/off state of battery replacement switch 101, and that electrically cuts off electric circuit L1 while battery replacement switch 101 is in the on state.

### TECHNICAL FIELD

The present disclosure relates to a control system for an electric vehicle.

### BACKGROUND ART

Conventionally, electric vehicles (for example, electric automobiles and electric scooters) equipped with batteries are known.

In recent years, there has been an increasing number of cases where an electric vehicle of this type is equipped with a battery replacement system. Such a battery replacement system is generally designed based on the concept of replacing a battery, when the storage power of the battery mounted on the vehicle has decreased, with another battery that has been fully charged at a battery replacement station, instead of charging the battery each time (see, for example, Patent Literature (hereinafter referred to as “PTL”)).

In this type of battery replacement system, the operation of a lock mechanism (for example, see FIGS. 3 and 4 to be described later) that supports and fixes a battery to a vehicle frame is controlled under the control of an electronic control unit (ECU), and the battery is removed from the vehicle frame and/or attached to the vehicle frame. At this time, the ECU establishes communication with a battery replacement station and, in cooperation with a battery replacement machine of the battery replacement station, causes the battery replacement machine to perform replacement of the battery mounted on the vehicle.

### CITATION LIST

### Patent Literature

### PTL

Japanese Patent Application No. 2023-134543

### SUMMARY OF INVENTION

### Technical Problem

Incidentally, this type of battery replacement system is currently under development, and has not yet reached the stage of identifying various problems that may arise during an actual use of a vehicle and optimizing the entire control system of the vehicle.

In such a background, the inventor of the present application has conceived a problem in that, in a situation where a vehicle is actually used, there is a possibility that a driver may perform a vehicle activation operation (that is, an ignition switch ON operation in a key cylinder) during battery replacement. In such a case, upon receiving a vehicle activation command from the key cylinder, a system main relay in an electrical circuit that connects the battery and a drive motor of the vehicle is brought into an on state, and a high voltage generated at a terminal portion of the battery is applied to a battery connector on a vehicle side in a non-connected state, which may cause arc discharge. As a result, situations may occur the battery connector becomes welded or other components are damaged.

Note that the system main relay is generally disposed in an output portion on a battery side, and is designed to be switched on by the ECU in order to make the vehicle ready for traveling when a vehicle activation operation is performed.

Further, when the vehicle activation operation is performed during the battery replacement, the ECU will notify the battery replacement station of an emergency stop command for a battery replacement procedure to avoid danger. As a result, there is a risk of unnecessarily redoing the battery replacement procedure or inducing an operation failure in the battery replacement machine of the battery replacement station.

An object of the present disclosure, which has been conceived in view of these problems, is to provide a control system for an electric vehicle capable of preventing a situation in which a vehicle activation operation is performed and arc discharge occurs in a battery connector during a battery replacement procedure.

Principally, the present invention that solves the aforementioned problem is a control system for an electric vehicle equipped with a battery, the control system including:
a vehicle electronic control unit (ECU);
an ignition power source that starts power supply to the vehicle ECU in response to a vehicle activation operation by a user;
a battery replacement switch that receives a replacement command operation for the battery from the user; and
a first relay that is disposed in an electric circuit connecting between the ignition power source and the vehicle ECU, so as to be in conjunction with an on/off state of the battery replacement switch, and that electrically cuts off the electric circuit while the battery replacement switch is in the on state.

### Advantageous Effects of Invention

According to a control system for an electric vehicle of the present invention, it is possible to prevent a situation in which a vehicle activation operation is performed and arc discharge occurs in a battery connector during a battery replacement procedure.

### BRIEF DESCRIPTION OF DRAWINGS

FIG. 1 illustrates an exemplary configuration of a vehicle (plan view);

FIG. 2 illustrates an exemplary mode of attaching a main battery to the vehicle;

FIG. 3 illustrates an exemplary configuration of a lock mechanism (unlocked state);

FIG. 4 illustrates another exemplary configuration of the lock mechanism (locked state);

FIG. 5 illustrates an appearance of the main battery;

FIG. 6 illustrates an exemplary drive mechanism of the lock mechanism;

FIG. 7 illustrates an exemplary configuration of a control system for the vehicle (initial state);

FIG. 8 illustrates another exemplary configuration of the control system for the vehicle (during normal operating); and

FIG. 9 illustrates still another exemplary configuration of the control system for the vehicle (during battery replacement).

### DESCRIPTION OF EMBODIMENTS

A preferred embodiment of the present disclosure will be described in detail with reference to the attached drawings. Note that elements having substantially the same functions are assigned the same reference numerals in the description and drawings to omit duplicated descriptions thereof.

Hereinafter, exemplary configurations of an electric vehicle (hereinafter, referred to as “vehicle C”) and a control system for vehicle C (hereinafter, referred to as “control system Cu”) according to an embodiment of the present invention will be described.

In the present embodiment, a battery replacement function of control system Cu will be mainly described. Here, a battery to be replaced in control system Cu is, for example, mounted on an electric vehicle such as an electric automobile or a hybrid automobile and is used as a drive power source for the vehicle (hereinafter, also referred to as a “main battery”).

### <Overall Configuration of Vehicle>

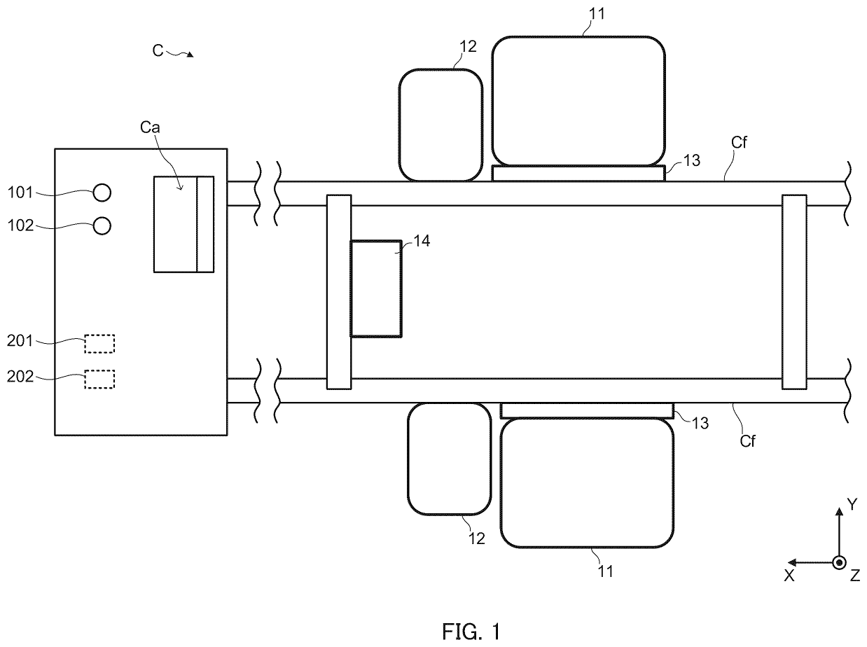

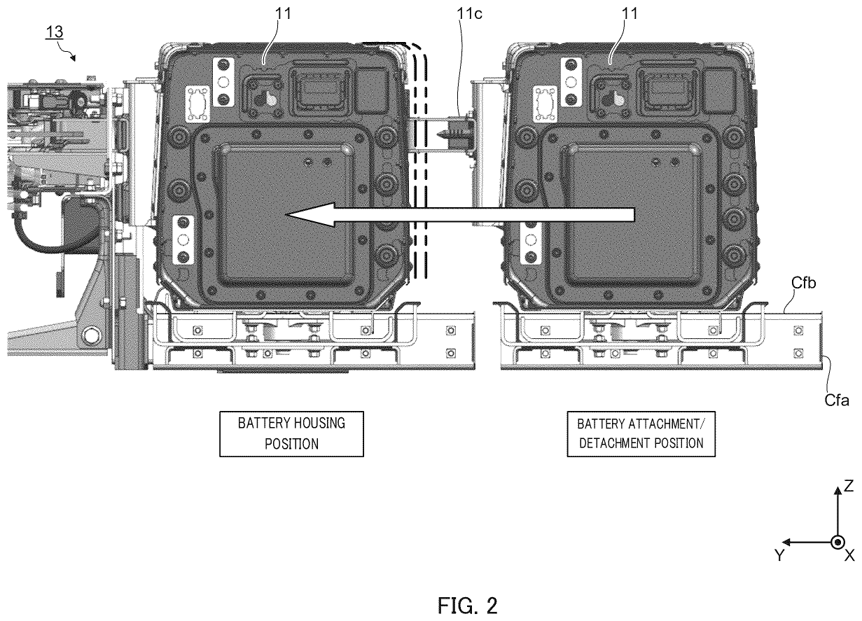

FIG. 1 illustrates an exemplary configuration of vehicle C (plan view). FIG. 2 illustrates an exemplary mode of attaching main battery 11 to vehicle C.

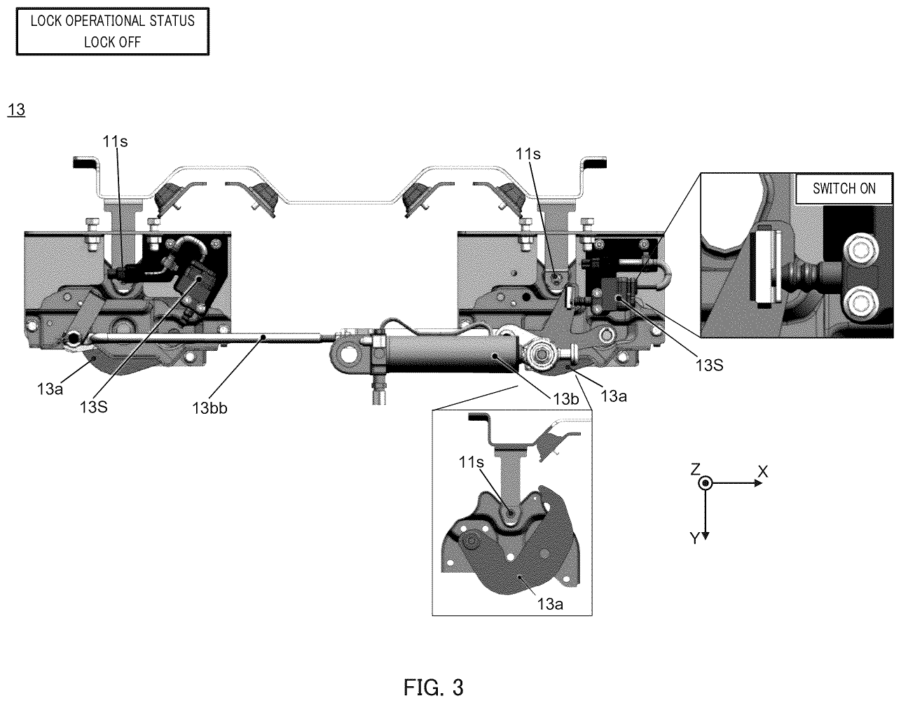

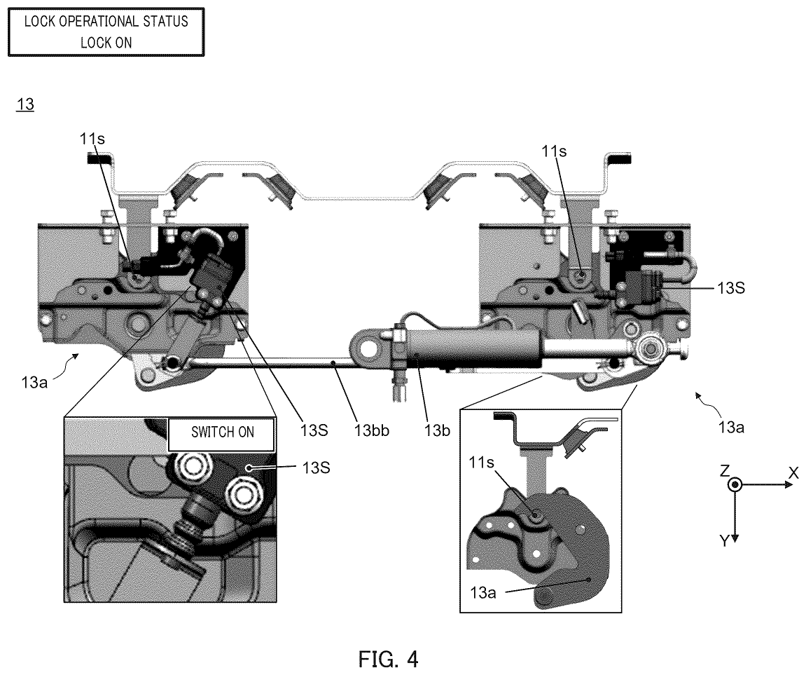

FIGS. 3 and 4 each illustrate an exemplary configuration of lock mechanism 13 that fixes main battery 11 to vehicle C (plan view). FIG. 3 illustrates an unlocked state of lock mechanism 13, and FIG. 4 illustrates a locked state of lock mechanism 13.

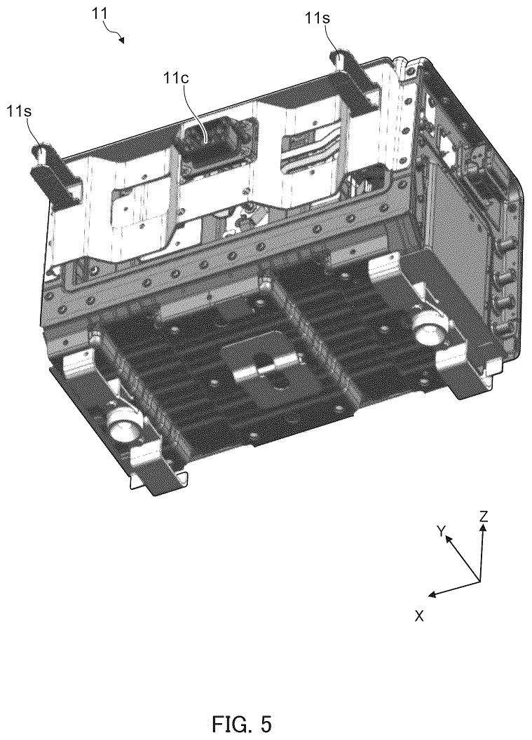

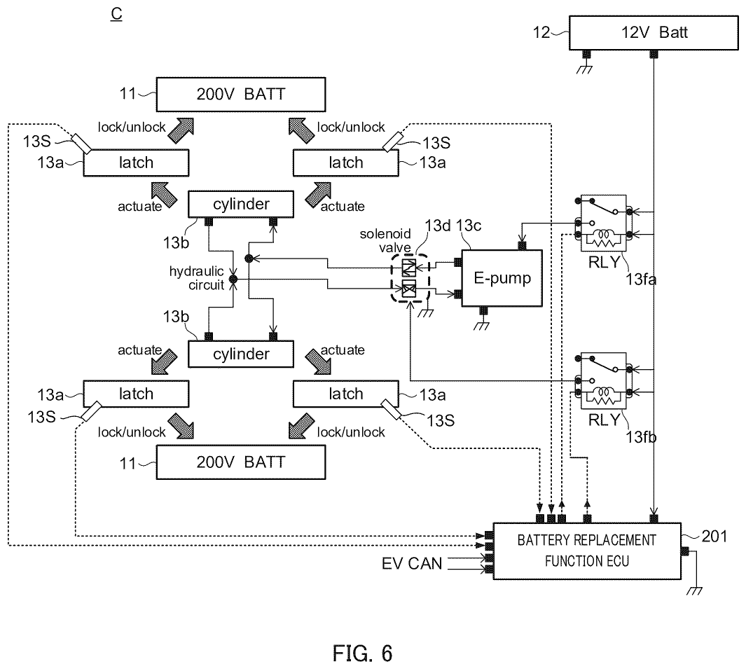

FIG. 5 illustrates an appearance of main battery 11. FIG. 6 illustrates an exemplary drive mechanism of lock mechanism 13.

Vehicle C is a vehicle, such as an electric automobile or a hybrid vehicle, which can travel using the drive power source of main battery 11. FIG. 1 illustrates, as an example, a configuration of a large-sized vehicle such as a truck. Note that vehicle frame Cf of vehicle C extends along a front-rear direction of the vehicle, is disposed on each side of left and right of the vehicle, and supports a vehicle body and various on-board devices. Further, vehicle frame Cf supports a cab that forms driver-seat Ca at a front portion of vehicle C. Vehicle frame Cf is formed of, for example, a steel bone material having a U-shaped cross section.

Vehicle C includes main battery 11, auxiliary battery 12, lock mechanism 13, drive motor 14, battery replacement switch 101, key cylinder 102, battery replacement function ECU 201, and vehicle ECU 202.

Main battery 11 is a high-voltage battery that supplies an operational power for driving vehicle C to drive motor 14. In the present embodiment, a battery pack of a 300 V class lithium-ion battery is used as main battery 11, for example.

Main battery 11 is detachably attached to a side-surface portion of vehicle frame Cf via lock mechanism 13. In the present embodiment, main battery 11 is attached to each of left-side vehicle frame Cf and right-side vehicle frame Cf.

Note that main battery 11 includes terminal portion 11c on a side surface, and is electrically connectable to a battery connector (not illustrated) on a vehicle C side via terminal portion 11c. Further, main battery 11 includes striker 11s that is rod-shaped for engaging with latch 13a of lock mechanism 13 (see FIG. 5).

As illustrated in FIG. 2, vehicle frame Cf includes placing table Cfb on which main battery 11 is placed and slide rail base Cfa that slidably supports placing table Cfb. Slide rail base Cfa is attached to an outer-side surface of vehicle frame Cf and extends in a horizontal direction from vehicle frame Cf toward a laterally outside of vehicle C. Further, slide rail base Cfa guides placing table Cfb to be slidable between a battery housing position and a battery attachment/detachment position in vehicle C.

FIG. 2 illustrates a state in which placing table Cfb is slid to the battery housing position from a state in which placing table Cfb is drawn out to the battery attachment/detachment position.

In vehicle C according to the present embodiment, when main battery 11 is to be housed in vehicle C, main battery 11 is placed on placing table Cfb when placing table Cfb is in the battery attachment/detachment position. Main battery 11 is then slid on slide rail base Cfa under a state of being placed on placing table Cfb, and is guided from the battery attachment/detachment position to the battery housing position. Main battery 11 is thus locked to vehicle frame Cf at the battery housing position using lock mechanism 13. At this time, terminal portion 11c of main battery 11 is connected to the battery connector on the vehicle C side, thereby completing the housing of main battery 11 in vehicle C.

In vehicle C according to the present embodiment, when main battery 11 is to be removed from vehicle C, for example, lock mechanism 13 is driven to release the locked state of main battery 11 to vehicle frame Cf. Main battery 11 is then slid by slide rail base Cfa under a state of being placed on placing table Cfb, and is guided from the battery housing position in vehicle C to the battery attachment/detachment position. Main battery 11 is thus, for example, lifted by a battery replacement machine of a battery replacement station at the battery attachment/detachment position and is removed from vehicle C.

Note that, for an example of the operation of the battery replacement machine of the battery replacement station, reference to, for example, the PTL of the related application by the applicant of the present application is encouraged.

Auxiliary battery 12 is a low-voltage battery that supplies an operational power to the on-board electrical components. Auxiliary battery 12 is, for example, a 12V lead-acid battery. Auxiliary battery 12 is fixed to a side-surface portion of vehicle frame Cf. In vehicle C according to the present embodiment, for example, an ECU (for example, battery replacement function ECU 201 and vehicle ECU 202 to be described later) and lock mechanism 13 operate with the power supplied from auxiliary battery 12 (see FIG. 6).

Lock mechanism 13 is fixed to vehicle frame Cf and attaches main battery 11 to vehicle frame Cf in a detachable manner (see FIGS. 3, 4, and 6). Note that, in FIGS. 3 and 4, main battery 11 is not illustrated, and only striker 11s attached to a side surface of main battery 11 is illustrated.

Lock mechanism 13 according to the present embodiment is configured to include latch 13a, hydraulic cylinder 13b, drive pump 13c, control valve 13d, first relay 13fa, and second relay 13fb.

Latches 13a are provided in a pair along a front-rear direction of vehicle frame Cf. Each of the pair of latches 13a is rotatably supported around a vertical axis with respect to a bracket attached to vehicle frame Cf. Each of the pair of latches 13a is a hook member that extends from an inside to an outside of vehicle frame Cf and is caught by striker 11s that is rod-shaped. Then, each of the pair of latches 13a rotates around the vertical axis in conjunction with the operation of hydraulic cylinder 13b.

That is, when locking main battery 11 to vehicle frame Cf, each of the pair of latches 13a rotates to one side around the vertical axis, engages with striker 11s attached to main battery 11, and thereby fixes main battery 11 to vehicle frame Cf. Meanwhile, when unlocking main battery 11 from vehicle frame Cf, each of the pair of latches 13a rotates to the other side around the vertical axis, releases the engaged state with striker 11s of main battery 11, and makes main battery 11 detachable from vehicle frame Cf.

Lock mechanism 13 typically holds the locked state in which main battery 11 is fixed to vehicle frame Cf when main battery 11 is to be housed in vehicle C. Further, lock mechanism 13 releases the locked state between main battery 11 and vehicle frame Cf when main battery 11 is replaced.

In lock mechanism 13, one side of the pair of latches 13a is directly connected to hydraulic cylinder 13b, and the other side of the pair of latches 13a is connected to hydraulic cylinder 13b via rod 13bb.

Further, lock mechanism 13 is provided with battery unlock detection sensors 13S respectively corresponding to the pair of latches 13a, which can detect whether main battery 11 is in the locked state or the unlocked state. Each battery unlock detection sensor 13S is configured of, for example, a contact-type switch, and an on/off state of the sensor changes in conjunction with lock mechanism 13 in accordance with a protruding operation and a retracting operation of a bracket attached to lock mechanism 13.

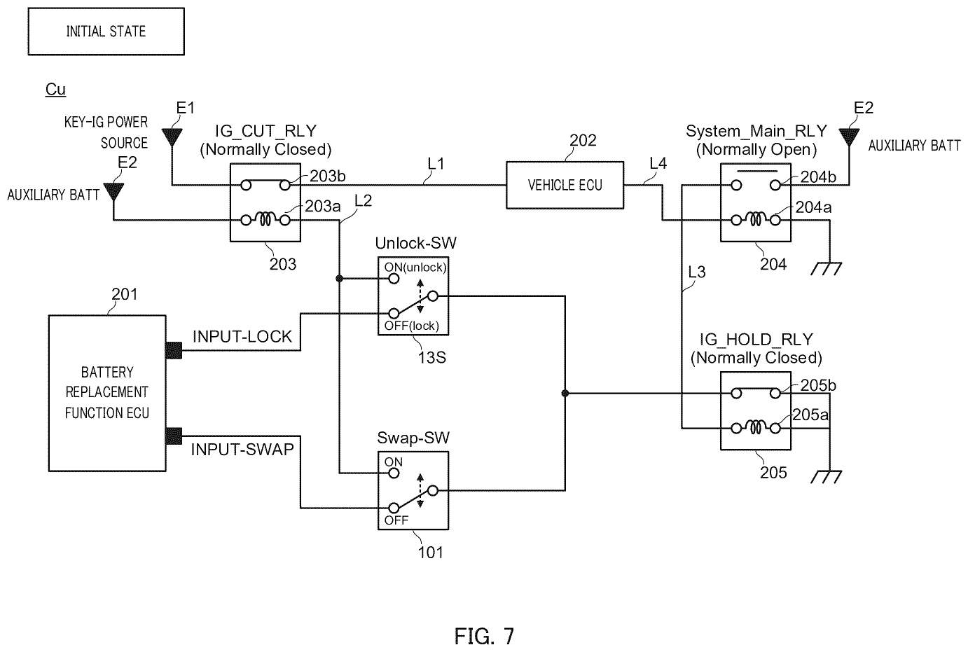

Detection signals from battery unlock detection sensors 13S are transmitted to battery replacement function ECU 201 and safety relay 203 (described later with reference to FIG. 7).

Hydraulic cylinder 13b is connected to a hydraulic circuit, and changes in state depending on operation states of drive pump 13c, which supplies hydraulic oil to the hydraulic circuit, and control valve 13d, which is disposed in the hydraulic circuit. That is, drive pump 13c sends high-pressure hydraulic oil to the hydraulic circuit, and control valve 13d controls a supply state of the hydraulic oil to hydraulic cylinder 13b. Thus, hydraulic cylinder 13b converts fluid energy of the hydraulic oil into mechanical energy to move the pair of latches 13a.

The operation state of hydraulic cylinder 13b is controlled by battery replacement function ECU 201 that controls drive pump 13c and control valve 13d. To be more specific, battery replacement function ECU 201 controls the operation of drive pump 13c by performing on/off control of first relay 13fa disposed in a line connecting between drive pump 13c and auxiliary battery 12 that supplies an operational power to drive pump 13c. Similarly, battery replacement function ECU 201 controls the operation of control valve 13d by performing on/off control of second relay 13fb disposed in a line connecting between control valve 13d and auxiliary battery 12 that supplies an operational power to control valve 13d.

Battery replacement function ECU 201 is a controller that operates lock mechanism 13 to switch between the locked state and the unlocked state of main battery 11 with respect to vehicle frame Cf. Further, battery replacement function ECU 201 is configured to be capable of communicating with the battery replacement station, and executes the replacement procedure of main battery 11 in cooperation with the battery replacement station.

Vehicle ECU 202 is a main controller that performs integral control of each component of vehicle C.

Vehicle ECU 202 switches on system main relay 204 that electrically connects between main battery 11 and drive motor 14 in order to make vehicle C ready for traveling when vehicle C is activated.

Here, vehicle ECU 202 operates with power supplied from ignition power source E1. Then, vehicle ECU 202 is activated by receiving power source supply from ignition power source E1, and upon its activation, switches on system main relay 204 (described later with reference to FIG. 7).

Vehicle ECU 202 and battery replacement function ECU 201 are, for example, microcontrollers configured to include a central processing unit (CPU), a read only memory (ROM), a random access memory (RAM), an input port, an output port, a communication module, and the like.

Key cylinder 102 and battery replacement switch 101 are, for example, operation units disposed on an instrument panel in front of driver seat Ca of vehicle C.

Key cylinder 102 is a conventionally publicly-known key cylinder that functions as an ignition switch and is configured integrally with the ignition switch of vehicle C. Key cylinder 102 receives a key for vehicle C held by a driver, and when an operation of rotating a rotor of key cylinder 102 to a vehicle activation specified position is performed with the key, the built-in ignition switch is turned on.

Battery replacement switch 101 receives a battery replacement command operation (refers to a replacement command operation for main battery 11; the same applies hereinafter) from the user. When receiving the battery replacement command operation from the user, battery replacement switch 101 transmits the replacement command to battery replacement function ECU 201.

### <Control System for Vehicle>

Next, a description will be given of a configuration of control system Cu for vehicle C, which is incorporated into vehicle C as a safety measure function during the battery replacement.

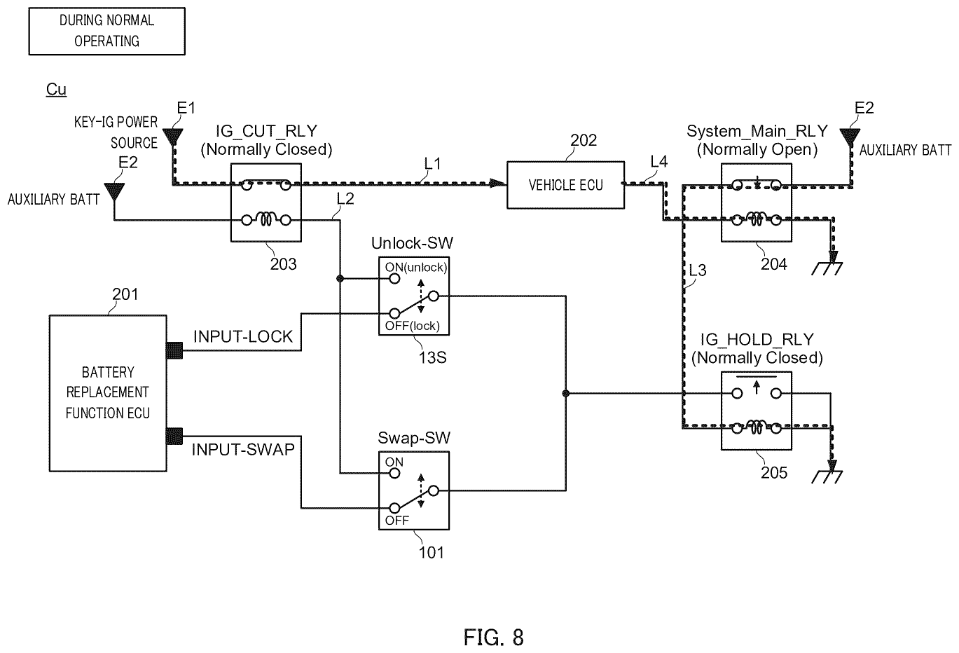

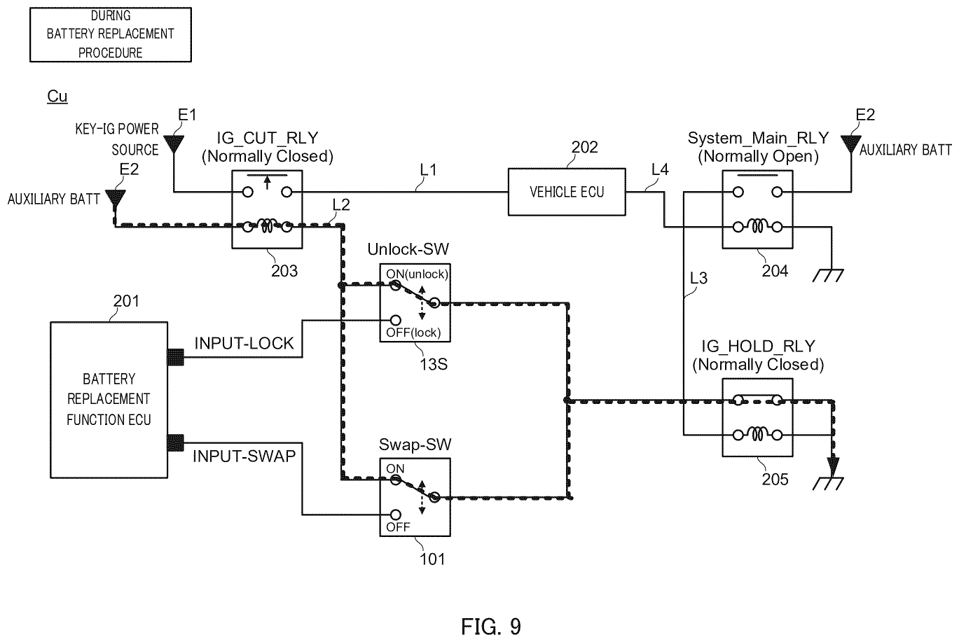

FIGS. 7 to 9 are each illustrate a configuration of control system Cu for vehicle C. FIG. 7 illustrates a state of control system Cu in an initial state in which vehicle C is not operating, FIG. 8 illustrates a state of control system Cu during normal operating of vehicle C (refers to during operating of vehicle other than during battery replacement, the same applies hereinafter), and FIG. 9 illustrates a state of control system Cu during the battery replacement procedure. Note that the dotted lines in FIGS. 8 and 9 represent the flow of current.

Control system Cu for vehicle C according to the present embodiment prevents vehicle ECU 202 from being activated during the battery replacement described above, thereby preventing system main relay 204 in the electric circuit connecting between main battery 11 and drive motor 14 from brought into an on state. That is, this prevents a situation in which arc discharge occurs in a battery connector on a vehicle C side due to the high voltage generated at terminal portion 11c of main battery 11.

System main relay 204 is designed to be switched on by vehicle ECU 202 in a case where the vehicle activation operation is performed, in order to make the vehicle ready for traveling.

Control system Cu includes safety relay 203 and hold relay 205 to achieve such a safety measure function during the battery replacement. Note that safety relay 203 and hold relay 205 are mounted on vehicle C together with vehicle ECU 202 and the like.

Note that L1 to L4 in FIGS. 7 to 9 illustrate the circuit network in vehicle C. L1 is an electric circuit for supplying power source from ignition power source E1 to vehicle ECU 202. L2 is a signal path for transmitting a signal related to an on/off state, from battery replacement switch 101 and battery unlock detection sensor 13S to safety relay 203. L3 is a signal path for transmitting a signal related to an on/off state, from system main relay 204 to hold relay 205. L4 is a signal path for transmitting a signal related to an on/off state, from vehicle ECU 202 to system main relay 204.

Ignition power source E1 is a low-voltage power source that starts supplying power source to each control circuit in vehicle C in response to a vehicle activation operation (that is, a key-on operation) by the user. Ignition power source E1 is configured to be in conjunction with the state of key cylinder 102 for the ignition switch, and starts supplying power source to each control circuit in vehicle C when the user performs the key-on operation on key cylinder 102. Note that ignition power source E1 is generated using, for example, the power of auxiliary battery 12.

Here, ignition power source E1 starts supplying power source to vehicle ECU 202 in response to the key-on of key cylinder 102. Vehicle ECU 202 operates with the power supplied from ignition power source E1.

Auxiliary battery power source E2 is a power source (for example, a 12V power source) supplied by auxiliary battery 12. Auxiliary battery power source E2 is capable of supplying power source at all times, regardless of an operating state of vehicle C.

Safety relay 203 (corresponding to “first relay” of the present invention) is disposed in electric circuit L1, which connects between ignition power source E1 and vehicle ECU 202, so as to be in conjunction with an on/off state of battery unlock detection sensor 13S and an on/off state of battery replacement switch 101.

As described above with reference to FIGS. 3 and 4, battery unlock detection sensor 13S is a sensor that monitors the state of lock mechanism 13 that fixes main battery 11 to vehicle frame Cf. Here, battery unlock detection sensor 13S is in the off state when lock mechanism 13 is in the locked state, and changes to the on state when lock mechanism 13 is brought into the unlocked state.

Further, as described above with reference to FIG. 1, battery replacement switch 101 is an operation unit that receives the battery replacement command operation from the user. Battery replacement switch 101 is in the off state when the battery replacement command is not performed, and is in the on state when the battery replacement command is performed.

Safety relay 203 electrically cuts off electric circuit L1 when battery replacement switch 101 is in the on state (that is, when the battery replacement command is being performed). Further, when battery unlock detection sensor 13S is in the on state (that is, when lock mechanism 13 is in the unlocked state), safety relay 203 electrically cuts off electric circuit L1. In other words, safety relay 203 cuts off electric circuit L1 that connects between ignition power source E1 and vehicle ECU 202 during the battery replacement.

More specifically, safety relay 203 is a normally-closed type relay, and includes coil portion 203a that operates upon receiving an electrical signal flowing through signal path L2, and contact portion 203b that opens and closes electric circuit L1 in conjunction with the operation of coil portion 203a. While no current is flowing through coil portion 203a, contact portion 203b maintains the on state and brings electric circuit L1 into an energized state (see FIG. 8). On the other hand, when the current flows through coil portion 203a, contact portion 203b changes to the off state and cuts off electric circuit L1 (see FIG. 9).

Here, battery replacement switch 101 and battery unlock detection sensor 13S are disposed in signal path L2 at a position where coil portion 203a of safety relay 203 is connected in series. Further, signal path L2 is configured such that, in response to battery replacement switch 101 or battery unlock detection sensor 13S being brought into the on state, current from auxiliary battery power source E2 flows through the signal path. Thus, when battery replacement switch 101 is brought into the on state (that is, when the battery replacement command is being performed), or when battery unlock detection sensor 13S is brought into the on state (that is, when lock mechanism 13 is in the unlocked state), coil portion 203a of safety relay 203 receives the current flowing through signal path L2 and changes contact portion 203b to the off state (that is, cuts off electric circuit L1).

Note that battery replacement switch 101 and battery unlock detection sensor 13S are connected to each other in parallel with respect to coil portion 203a of safety relay 203 via signal line L2. Then, battery replacement switch 101 and battery unlock detection sensor 13S independently and separately change, in accordance with their own on/off states, the state of safety relay 203.

That is, battery replacement switch 101 and battery unlock detection sensor 13S function as fail-safes to reliably prevent the activation of vehicle ECU 202 during the battery replacement procedure. For example, in a late stage of the battery replacement procedure, the user may mistakenly believe that the battery replacement is completed, turn off battery replacement switch 101, and perform a vehicle activation operation (that is, a key-on operation). In such a case, when no battery unlock detection sensor 13S is provided, vehicle ECU 202 can be activated and system main relay 204 can be thus turned on even though the battery lock for vehicle C is not completed (that is, there is a risk of arc discharge occurring in the battery connector portion). Such a situation can be prevented by causing an on/off state of safety relay 203 to be in conjunction with an on/off state of a detection signal from battery unlock detection sensor 13S.

Safety relay 203 is disposed in electric circuit L1, which connects between ignition power source E1 and vehicle ECU 202, so as to be in conjunction with a state change of system main relay 204. Further, while system main relay 204 is in the on state, safety relay 203 maintains an energized state of electric circuit L1 regardless of the state(s) of battery replacement switch 101 and/or battery unlock detection sensor 13S (see FIG. 8). Thus, it is possible to prevent a situation in which the operation of vehicle ECU 202 is forcibly shut down due to an erroneous operation of the user (for example, the operation of turning on battery replacement switch 101) while system main relay 204 is in the on state (that is, while the vehicle is in operating).

The forced-shutdown prevention function of vehicle ECU 202 is achieved by hold relay 205 here.

Hold relay 205 (corresponding to “second relay” of the present invention) is disposed in signal path L2 so as to be in conjunction with an on/off state of the operating state of vehicle ECU 202. More specifically, hold relay 205 is a normally-closed relay, and includes coil portion 205a that operates upon receiving an electrical signal flowing through signal path L3, and contact portion 205b that opens and closes signal path L2 in conjunction with the operation of coil portion 205a. Here, signal path L3 is a signal path that allows current from auxiliary battery power source E2 to flow in conjunction with an on/off state of system main relay 204. That is, while system main relay 204 is in the on state (that is, while the vehicle is operating), contact portion 205b is brought into the off state, and hold relay 205 cuts off signal path L2. On the other hand, while system main relay 204 is in the off state (that is, while the vehicle is not operating), contact portion 205b is brought into the on state, and hold relay 205 maintains an energized state of signal path L2.

Note that system main relay 204 is a normally-open type relay, and includes coil portion 204a that operates upon receiving an electrical signal (that is, an activation command signal from vehicle ECU 202) that flows through signal path L4 connected to vehicle ECU 202, and contact portion 204b that opens and closes signal path L3 in conjunction with the operation of coil portion 204a. Then, while vehicle ECU 202 is in the on state (that is, while the vehicle is operating), contact portion 204b is brought into the off state, and system main relay 204 energizes signal path L3 to allow the current from auxiliary battery power source E2 to flow through signal path L3. On the other hand, while vehicle ECU 202 is in the off state (that is, while the vehicle is not operating), contact portion 204b is brought into the on state, and system main relay 204 cuts off signal path L3 to prevent the current from flowing from auxiliary battery power source E2 to hold relay 205.

In such a configuration, while system main relay 204 is in the on state (that is, while the vehicle is operating), hold relay 205 cuts off the transmission of a signal related to the on/off states of battery replacement switch 101 and battery unlock detection sensor 13S to coil portion 203a of safety relay 203 via signal path L2. That is, while system main relay 204 is in the on state (that is, while the vehicle is operating), the on state of safety relay 203 is maintained regardless of the on/off states of battery replacement switch 101 and battery unlock detection sensor 13S (see FIG. 8).

Thus, it is possible to prevent a situation in which the operation of vehicle ECU 202 is forcibly shut down due to an erroneous operation of the user (for example, the operation of turning on battery replacement switch 101) while system main relay 204 is in the on state.

### [Effects]

As described above, control system Cu for vehicle C according to the present embodiment includes:
a vehicle electronic control unit (ECU);
an ignition power source that starts power supply to the vehicle ECU in response to a vehicle activation operation by a user;
a battery replacement switch that receives a replacement command operation for the battery from the user; and
a first relay that is disposed in an electric circuit connecting between the ignition power source and the vehicle ECU, so as to be in conjunction with an on/off state of the battery replacement switch, and that electrically cuts off the electric circuit while the battery replacement switch is in the on state.

According to control system Cu for vehicle C according to the present embodiment, the operation of safety relay 203 can physically prevent the activation of vehicle ECU 202 during the replacement procedure of battery 11. That is, it is possible to prevent a situation in which arc discharge occurs, due to the vehicle activation, at a connector on a battery side or at a socket on a vehicle C side that receives the connector, causing these components to be welded to each other.

Further, it is possible to prevent a situation in which unnecessary redoing of the battery replacement procedure occurs and an operation failure in the battery replacement machine of the battery replacement station is induced.

Further, control system Cu for vehicle C according to the present embodiment further includes: a battery unlock detection sensor that detects an unlocked state of a lock mechanism for fixing the battery to the electric vehicle, in which:
the first relay is disposed in the electric circuit so as to be in conjunction with an on/off state of a detection signal of the battery unlock detection sensor, and that electrically cuts off the electric circuit while the battery unlock detection sensor is detecting the unlocked state, and
the battery replacement switch and the battery unlock detection sensor are connected to each other in parallel to a coil portion of the first relay via a signal line, and function as fail-safes to prevent activation of the vehicle ECU during a replacement procedure of the battery.

Thus, during the replacement procedure of battery 11, it is possible to more reliably prevent the activation of vehicle ECU 202 and to prevent a situation in which arc discharge occurs at the connector on the battery side or at the socket on the vehicle C side that receives the connector, causing these components to be welded to each other.

Further, control system Cu for vehicle C according to the present embodiment further includes: a second relay that is disposed in a signal path transmitting a signal related to the on/off state of the battery replacement switch to the first relay, so as to be in conjunction with an operating state of the vehicle ECU, in which
the second relay allows transmission of the signal in the signal path while the vehicle ECU is not operating, and the second relay cuts off the transmission of the signal in the signal path while the vehicle ECU is operating.

Thus, it is possible to prevent a situation in which, while vehicle C is operating, an erroneous operation of the user (for example, an operation of turning on battery replacement switch 101) forcibly shuts down the operation of vehicle ECU 202 and thus causes an operational failure in vehicle C.

The present invention is not limited to the above embodiment and can be applied to various modified modes.

For example, in the above embodiment, vehicle frame Cf including slide rail base Cfa has been described as an example of vehicle C to be applied to the present invention, but any support mode of main battery 11 is possible for achieving vehicle C according to the present invention.

Further, in the above embodiment, as an example of lock mechanism 13 to be applied to the present invention, a mode has been described in which main battery 11 is locked by a pair of latches 13a. However, lock mechanism 13 used in the present invention is optional, and other lock mechanisms may be used.

Further, in the above embodiment, a mode has been described in which the user performs the vehicle activation operation using key cylinder 102. In control system Cu according to the present invention, however, a method may be employed in which the user performs a vehicle activation operation using a power switch or the like.

The specific examples of the present disclosure have been described in detail above, but these specific examples are mere examples and do not limit the appended claims. The technology described in the appended claims embraces various modifications and changes made in accordance with the specific examples described above.

The disclosure of Japanese Patent Application No. 2024-73940, filed on Apr. 30, 2024 including the specification, drawings and abstract, are incorporated herein by reference in its entirety.

### INDUSTRIAL APPLICABILITY

According to a control system for an electric vehicle of the present invention, it is possible to prevent a situation in which a vehicle activation operation is performed and arc discharge occurs in a battery connector during a battery replacement procedure.

### REFERENCE SIGNS LIST

C Vehicle
Cu Control System
11 Main battery
12 Auxiliary battery
13 Lock mechanism
13S Battery unlock detection sensor
14 Drive motor
101 Battery replacement switch
102 Key cylinder
201 Battery replacement function ECU
202 Vehicle ECU
203 Safety relay
204 System main relay
205 Hold relay
E1 Ignition power source
E2 Auxiliary battery power source

1. A control system for an electric vehicle equipped with a battery, the control system comprising:
a vehicle electronic control unit (ECU);
an ignition power source that starts power supply to the vehicle ECU in response to a vehicle activation operation by a user;
a battery replacement switch that receives a replacement command operation for the battery from the user; and
a first relay that is disposed in an electric circuit connecting between the ignition power source and the vehicle ECU, so as to be in conjunction with an on/off state of the battery replacement switch, and that electrically cuts off the electric circuit while the battery replacement switch is in the on state.

2. The control system according to claim 1, further comprising a battery unlock detection sensor that detects an unlocked state of a lock mechanism for fixing the battery to the electric vehicle, wherein:
the first relay is disposed in the electric circuit so as to be in conjunction with an on/off state of a detection signal of the battery unlock detection sensor, and that electrically cuts off the electric circuit while the battery unlock detection sensor is detecting the unlocked state, and
the battery replacement switch and the battery unlock detection sensor are connected to each other in parallel to a coil portion of the first relay via a signal line, and function as fail-safes to prevent activation of the vehicle ECU during a replacement procedure of the battery.

3. The control system according to claim 1, further comprising a second relay that is disposed in a signal path transmitting a signal related to the on/off state of the battery replacement switch to the first relay, so as to be in conjunction with an operating state of the vehicle ECU, wherein
the second relay allows transmission of the signal in the signal path while the vehicle ECU is not operating, and the second relay cuts off the transmission of the signal in the signal path while the vehicle ECU is operating.
